(19) United States
(12) Patent Application Publication
(10) Pub. No.: US 2006/0244908 A1
(43) Pub. Date: Nov. 2, 2006

(54) Colored contact lens

(75) Inventor: Gerald G. Cano, Export, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Glucose Sensing Technologies, LLC, Export, PA (US)

(21) Appl. No.: 11/451,865

(22) Filed: Jun. 13, 2006

Related U.S. Application Data
(63) Continuation-in-part of application No. 10/929,615, filed on Aug. 30, 2004, now Pat. No. 7,059,719.

(51) Int. Cl. G02C 7/04

(52) U.S. Cl. 351/162

(57) ABSTRACT

The present invention is a colored contact lens whose color is produced by Bragg diffraction. The contact lens includes a hydrogel comprised of either dimethyl acrylamide, HEMA (hydroxylethyl methacrylate) or 3-(trimethoxysilyl)propyl methacrylate and a light diffracting crystalline colloidal ordered array of particles polymerized in the hydrogel. The crystalline colloidal ordered array has a fixed lattice spacing.

### CROSS REFERENCE TO RELATED APPLICATION

This application is a Continuation-in-Part of co-pending U.S. patent application Ser. No. 10/929,615, entitled “Contact Lenses Colored with Crystalline Colloidal Array Technology”, filed on Aug. 30, 2004 and published as U.S. Patent Application Publication No. U.S. 2005/0094094 on May 5, 2005, the contents of which are incorporated herein by reference.

### BACKGROUND OF THE INVENTION

1. Field of the Invention

The invention relates to expanding the materials that take advantage of self-assembled colloidal arrays to diffract visible light to address expanded use of Bragg diffraction that results from the spacing and periodicity of the self-organized like-charged nanoscopic particles. More specifically, the invention recognizes the material needs associated with certain applications beyond solid narrow band radiation filters disclosed in U.S. Pat. No. 5,281,370 and U.S. Pat. No. 6,123,845, the contents both of which are incorporated herein by reference. More specifically, the patent broadens hydrogels capable of allowing formation and maintenance of self-organized nanoscopic arrays to produce vibrant sparkling colors. These hydrogels are suitable for use in soft contact lenses, specifically to provide desirable colors for cosmetic effects.

2. Description of Related Art

Soft contact lenses are usually molded of a transparent hydrogel. The hydrogel is typically chosen because it is safe to be in contact with the eye and has properties that allow the eye to feel comfortable when the lens is in place over the surface of the eye. These hydrogels include dimethyl acrylamide, hydroxy ethyl methacrylate (HEMA), and 3-(trimethoxysilyl)propyl methacrylate.

Soft cosmetic contact lenses that provide cosmetic effects are either opaque or translucent. Translucent lenses help to intensify color of light color eyes. Opaque lenses change the color of either light or dark colored eyes.

Dyes and pigments are used to color a soft contact lens for cosmetic purposes. These are limiting in vibrancy, may leak from the lens body, possibly staining the surface of the eye, and require individual approval for use in a lens by the Food & Drug Administration (FDA).

U.S. Pat. No. 6,196,683 for “Pearlescent Contact Lens” discusses coating materials that are characterized as “pearlescent pigments.” These materials utilize titanium dioxide over mica platelets. The titanium dioxide pigments may also contain conventional color pigment. The coated mica platelets are transparent, and reflect light due to their smooth surfaces and relatively high indices of refraction. These pigments, through the light interference patterns they yield, often provide “color” without the need for any added conventional non-pearlescent pigment. In addition, certain such iridescent-type pigments have the ability to provide a metallic foil looking appearance which causes the effect of changing color on variation of an angle of light incidence or upon the viewing angle of an observer.

These pearlescent pigments are sold by various entities. A preferred method of incorporating these into a contact lens is through printing. In one such contemplated printing process, the pearlescent pigment is added to a conventional polymeric binder, solvent and bonding agent.

U.S. Patent Application Publication No. 2004/0114101 for “Contact Lenses with Color Shifting Properties” discusses coloring of cosmetic contact lenses to produce “color shifting” (without dyes or pigments). The process involves layering hydrogels of different refractive index. Each layer contains a dispersion of very fine particles of “pigment,” the type of pigment specific to a layer to establish a refractive index. Each layer must have a precise thickness. The layers act in concert to cause constructive and destructive interference of particular wavelengths of light. It is this interaction of light with the various layers that causes diffraction so that the material takes on a color. In effect, the color shifting is not produced by one material, but multiple materials. The publication states that each layer used HEMA as the binder. Paragraph [0100] of the publication states: “Colors were subtle but with dramatic color shifting rainbow effects. The color varied and changed as viewing angle or angle of incident light changed. Accordingly, a contact lens, in accordance with a specific embodiment of the invention, comprises an image component effective in producing a rainbow colored spectral appearance.” This, in effect, implies an inability to achieve a specific color effect that is preserved relative to viewing angle. Creating a specific color is important in satisfying the expectations of the wearer.

Other prior art that can potentially yield material for providing color to soft contact lenses was developed to create narrow band filters, e.g., the above incorporated U.S. Pat. No. 5,281,370, wherein methods to make solid crystalline narrow band radiation filters are disclosed. Other prior art also focuses on the composition of types of polymerized self-organized crystalline colloidal arrays for use as radiation filters, e.g., the above-incorporated U.S. Pat. No. 6,123,845. Other potential applications are referenced for eye protection and sensor protection, providing an efficient shield from high intensity radiation.

In one composition, the colloidal particles are surrounded by a polymer solution which is polymerized to rigidize the structure. The polymers identified for this purpose were chosen from groups known at the time to allow self-assembly of the charged colloidal particles, namely, acrylamide and bisacrylamide.

The method for making this solid filtering material for filtering a predetermined wavelength band from a broad spectrum includes:

a. Creating an organized structure in a medium through mutual repulsion of like-charged colloidal particles;

b. Adding a polymerization agent;

c. Polymerizing the medium around the particles;

d. Introducing an ultraviolet nonionic photoinitiator; and

e. Exposing the medium to ultraviolet light.

The filter material is conceptually applicable to providing color to soft contact lenses for cosmetic effects.

The above-incorporated U.S. Patent Application Publication No. 2005/0094094 for “Contact Lenses Colored with Crystalline Colloidal Array Technology”, discloses the use of crystalline colloidal arrays for providing color to soft contact lenses. The spacing of the colloidal array may remain constant such that the color added to the lens is relatively constant, depending only on angle of observation. Alternatively, the spacing may change due to the action of a stimulus so as to alter the color of the lens, making color variation possible due to angle of view. This publication does not specify hydrogels appropriate for constructing soft contact lenses.

Other examples of tinted or colored contact lenses can be found in U.S. Pat. No. 4,447,474 to Neefe; U.S. Pat. No. 4,719,657 to Bawa; U.S. Pat. No. 5,414,477 to Jahnke; U.S. Pat. No. 5,574,517 to Pang et al.; and U.S. Pat. No. 6,164,777 to Li et al.

### SUMMARY OF THE INVENTION

Needed in the art of soft contact lenses is material that provides vibrant sparkling color to the wearer's eye without the use of dyes or inks. Desirably, the material is a hydrogel that can be used to make the soft contact lens. Color should not leach out of the lens and the color should be vibrant and sparkling. Desirably, the lens presents a viewer a specific color that is, desirably, independent of viewing angle.

The hydrogel can be formed from base material composed of either dimethyl acrylamide, hydroxylethyl methacrylate (HEMA), or 3-(trimethoxysilyl)propyl methacrylate. The monodisperse colloidal particles can self assemble in the base material so that the resultant material is applicable for providing color elements and color to a soft contact lens.

Each of the foregoing hydrogels is formulated with a self assembled array of like-charged particles that diffract visible light and reflect a specific wavelength. Light that is not reflected is transmitted. The array forms because of electrostatic repulsion between monodisperse, highly charged colloidal particles in low ionic strength aqueous solutions. The particles form cubic arrays with lattice spacing of several hundred nanometers so that the array can diffract visible light.

The colloidal particles used are monodisperse in size, and possess numerous (>1000) strong acid surface groups. The ionization of these groups in water causes strong electrostatic repulsions between particles. At high concentrations (˜10¹³ particles/cc) the colloidal particle dispersion self-assembles into either a face centered cubic array or a body centered cubic array.

The array lattice constant can be fabricated to be many times the particle diameter. Thus, the lattice constant can be easily fabricated to have a spacing that diffracts light in the visible spectral region.

### DETAILED DESCRIPTION OF THE INVENTION

Previous work on crystalline colloidal array material, such as the work disclosed in the above-incorporated U.S. Pat. No. 6,123,845, has been limited to uses such as light filters and has focused on a limited set of monomers that are generally easy to produce in the laboratory, but are not the best monomers for other specific applications.

The present invention is crystalline colloidal array material that is suitable for inclusion in soft contact lenses to provide vibrant, sparkling color. Generally, the material includes four components:

1. a soft durable gel component that is comfortable when in contact with the eye;

2. highly charged monodispersed colloidal particles;

3. a cross-linker; and

4. an initiator.

While there are numerous hydrogels, three are widely used in the manufacture of soft contact lenses. These are (1) dimethyl acrylamide, (2) hydroxylethyl methacrylate, and (3) 3-(trimethoxysilyl)propyl methacrylate. Each is safe to handle, is biocompatible, and provides a clear durable lens with characteristics that are beneficial while wearing the lens.

The colloidal particles can be selected from materials such as polystyrene, polymethyl methacrylate, silica, silicon dioxide, aluminum oxide and fluorinated polymers. Conditions must be created within the particular hydrogel to allow for uniform assembly of the particle array. The work done to produce a colored soft lens material has involved primarily polystyrene particles. For a given color, the particles have a uniform diameter. This specific diameter is typically from about 90 microns to about 250 microns. In material produced in the laboratory, polystyrene particles were used. Care must be exercised in the chemistry to ensure that the material remains clear, that is, does not become cloudy due to precipitation of the colloidal particles or instability of the particles. The cross linker provides the physical consistency of the final material and is dependent on the hydrogel monomer.

The initiator is used in conjunction with an energy source to cause polymerization. Energy can be in the form of heat, visible light and/or ultraviolet light. An initiator is specific to each. As polystyrene particles were used, heat is desirably not used to cause polymerization. Instead, ultraviolet light and visible light are preferred.

It is possible to produce material that, when polymerized, diffracts colors from the violet to red end of the visible spectrum. Color diffraction is controlled by particle spacing which, in turn, is controlled by the concentration of particles. Colors produced were sparkling and vibrant, showing no cloudiness. In fact, looking through the material, it is practically clear, having only a slight orange tint. Material that reflected yellow or near yellow was the most difficult to produce as the component of the visible spectrum that causes the eye to perceive yellow is only about 20 nanometers.

Any suitable method can be utilized to form the soft contact lenses of the present invention. Examples of suitable methods to form the soft contact lenses of the present invention can be found in the above-incorporated U.S. Pat. No. 5,281,370, especially in claims 9 and 10 thereof. However, this is not to be construed as limiting the invention since it is envisioned that any suitable and/or desirable method for forming soft contact lenses in accordance with the present invention may be utilized.

While the invention has been described as a hydrogel material that produces vibrant sparkling colors due to the spacing of a self-assembled colloidal structure, the material has features that make for durable, safe and comfortable contact with the eye. Those of skill in the art will recognize modification of structure, materials, procedure and the like that will still fall within the scope of the invention and the following claims.

The invention claimed is:

1. A colored contact lens whose color is produced by Bragg diffraction comprising:
a hydrogel comprised of either dimethyl acrylamide, HEMA (hydroxyl ethyl methacrylate) or 3-(trimethoxysilyl)propyl methacrylate; and
a light diffracting crystalline colloidal ordered array of particles polymerized in said hydrogel, said crystalline colloidal ordered array having a fixed lattice spacing.

2. A method of coloring all or parts of a contact lens using Bragg diffraction comprising:
producing a hydrogel with a light diffracting crystalline colloidal ordered array of particles polymerized in said hydrogel, wherein said crystalline colloidal array has a fixed lattice spacing and said hydrogel comprises either dimethyl acrylamide, HEMA (hydroxylethyl methacrylate) or 3-(trimethoxysilyl)propyl methacrylate.
